(19) United States
(12) Patent Application Publication
(10) Pub. No.: US 2011/0311855 A1
(43) Pub. Date: Dec. 22, 2011

(54) Methods and systems for making separators and devices arising therefrom

(76) Inventors: Shufu Peng, Sunnyvale, CA (US); Lawrence S. Pan, Los Gatos, CA (US); Clark Dong, Los Gatos, CA (US)

(21) Appl. No.: 12/876,090

(22) Filed: Sep. 3, 2010

Related U.S. Application Data
(60) Provisional application No. 61/275,851, filed on Sep. 3, 2009.

(51) Int. Cl. H01M 2/16; H01M 4/62; B05D 5/12

(52) U.S. Cl. 429/144; 427/466; 427/58; 429/232

(57) ABSTRACT

The invention provides solutions to the problems and needs stated above by providing battery separators that are inexpensive and easy to produce, provide superior performance over traditional separators, and provide robust safety. Towards those ends, the invention provides, in one aspect, the invention provides for a battery electrode comprising: an electrode having a surface, the electrode comprising: a plurality of active material particles; and, a plurality of electrically conductive particles, wherein the active material particles are capable of reversibly storing ions; a separator layer upon the electrode surface, the separator layer having top and bottom surfaces, the bottom surface facing each electrode surface, the separator layer comprising: a plurality of organic polymer particles, each particle having a gross cross sectional dimension between 0.1 μm and 250 μm and comprising a plurality of organic polymer chains, wherein at least some of the organic polymer chains are covalently cross-linked to each other; and, a polymeric binder, wherein the plurality of organic polymer particles are embedded in the polymeric binder.

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### SEQUENCE LISTING

Not Applicable

### FIELD OF THE INVENTION

The invention generally relates to the field of battery electrode manufacturing, preferably lithium-ion battery electrode manufacturing. The invention generally pertains to the field of energy storage, batteries, lithium-ion (Li—ion) batteries, advanced vehicles technology, and reduction of national reliance upon foreign petroleum products. The invention relates to battery separators and methods of forming the same. The invention also relates to manufacturing systems for applying a coating or coatings to surfaces of substrates. The invention further relates to the field of energy efficiency, and environmental protection

### BACKGROUND

Lithium ion batteries play an important part in today's high-technology world. Reaching new markets, lithium ion batteries offer the promise of high energy capacity/high power output in relatively lightweight and compact formats when compared to traditional lead acid, nickel metal anhydride, or nickel cadmium batteries

Secondary batteries, also know as rechargeable batteries, generally comprise the following six components: 1) an anode current collector; 2) a cathode attached to the anode; 3) an anode attached to a second current collector; 4) a separator between the anode and cathode to prevent their direct contact; 5) an electrolyte; and, 6) a housing to contain and protect the preceding six parts. Lithium-ion batteries are very popular for portable electronic devices and handheld power tools. A growing interest in lithium ion batteries has emerged in the transportation industry in an effort to reduce emissions and reliance on foreign sources of oil by improving vehicle fuel efficiency. Lithium ion batteries are typically manufactured by coating aluminum and copper foils with cathode and anode materials, respectively. The electrodes are then mated with the cathode and anode materials facing each other with a separator in between. The separator typically is a one or three ply polymer sheet that is ion porous and is an electrical insulator. The electrodes must never contact one another so as to avoid thermal runaway.

Problems with sheet type separators include cost, tendency to be dimensionally unstable and are thick, from about 100 μm to 300 μm, in many cases. Dimensional instability can lead to the separator shrinking in the x,y plane and thus revealing opposing electrodes directly to one another, possibly permitting their direct contact that can lead to thermal runaway and fire. This can be especially problematic in wound cells where as the cell is charged or discharged, dimensional changes in the anode and cathode can occur due to heat changes and material expansions during lithiation and de-lithiation. The windings near the center core of the wound cell experience great pressures urging the electrodes towards one another. With the separator shrinking, the possibility of the opposing electrodes directly contacting one another rises greatly and can lead to a spontaneous overheating, out gassing, often with flame. Accordingly, there is a need for a battery separator is resistant to x,y dimensional change.

A battery separator also serves to maintain a “z” dimension spacing between each of the battery cell's electrodes to prevent their contact. In typical cells, the z-dimensionality is maintained by the thickness of the polymer sheets used. In the case of the commercially available tri-layer separators, the two outer layers serve to maintain x,y dimensionality while the middle layer serves to maintain z dimensionality and electrode spacing when the cell is operating at normal temperatures, and reduces its z dimension when melting during a thermal overload condition. It is the melting and reduction in z dimension that serves to “heal” the middle layer of its pores thereby shutting down ion flow between the electrodes of the cell. With the distance between electrodes now reduced, any shrinkage in the x,y plane along the surface of the electrodes can yield a situation where the electrodes face each other in the absence of a separator certain areas of the cell. As the thermal overload condition worsens and causes swelling of the cell components, the areas of the two electrodes where the separator has receded may contact each other as the z dimension of the separator reduces thus leading to a potential fire situation.

Accordingly, there is a need for a battery separator that maintains its z dimensionality during thermal overload. There also is a need for a method for producing and applying battery separators to electrodes that provides for uniform ion permeability between battery electrodes while maintaining electrode spacing within the battery cell. These objectives all need to be achieved in a cost efficient manner There is a need for a simple way to achieve a tight bond between a cell's electrodes and its separator. There is also a need to reduce the weight of cells, especially those used in vehicles since large numbers of cells will likely be used to power the vehicle. There is also a need for a separator that rapidly adsorbs electrolyte solvent mixtures to prevent “separator dry spots” that reduce cell performance. Embodiments of the invention address the above noted problems and other problems, individually and collectively.

### SUMMARY OF THE INVENTION

The invention provides solutions to the problems and needs stated above by providing battery separators that are inexpensive and easy to produce, provide superior performance over traditional separators, and provide robust safety. Towards those ends, the invention provides, in one aspect, the invention provides for a battery electrode comprising: an electrode having a surface, the electrode comprising: a plurality of active material particles; and, a plurality of electrically conductive particles, wherein the active material particles are capable of reversibly storing ions; a separator layer upon the electrode surface, the separator layer having top and bottom surfaces, the bottom surface facing each electrode surface, the separator layer comprising: a plurality of organic polymer particles, each particle having a gross cross sectional dimension between 0.1 μm and 250 μm and comprising a plurality of organic polymer chains, wherein at least some of the organic polymer chains are covalently cross-linked to each other; and, a polymeric binder, wherein the plurality of organic polymer particles are embedded in the polymeric binder.

In some embodiments the plurality of organic polymer particles may be porous or non-porous, or a mixture of porous and non-porous particles. In preferred embodiments, the separator layer comprises pores having a pore diameter and that are permeable to lithium ions, the separator being substantially not electrically conductive.

In some embodiments, the separator layer may have pores having a monomodal pore size distribution ranging from about 5 nm to 500 nm or a bimodal pore size distribution, the first mode ranging from about 5 nm to 100 nm, and the second mode ranging from about 100 nm to about 500 nm.

In some highly preferred embodiments, the polymeric binder is electrochemically compatible with materials found within lithium ion cells.

In some embodiments, the organic polymer particles have a cross-sectional dimension ranging from about 1 and 10 nm or ranging from about 10 and 50 nm or ranging from about 10 and 100 nm or ranging from about 20 and 2000 nm or ranging from about 1 μm and 10 μm or ranging from about 0.05 μm and 10 μm or ranging from about 1 μm and 100 μm.

In some embodiments, the organic polymer particles have an average porosity ranging from about 10% to 95% or ranging from about 40% to 95% or ranging from about 20% to 80% or ranging from about 30% to 80% or ranging from about 40 to 80%.

In some embodiments, the organic polymer chains comprise substantially the same type of organic polymer chains or the organic polymer chains comprise at least two different types of polymer chains. In some embodiments, the organic polymer chains may comprise polymers selected from the from the group consisting of: acrylonitrile butadiene styrene (ABS); allylmethacrylate; polyacrylonitrile (PAN); acrylic; polyamide; polyaramides; polyacrylamide; polyvinylcaprolactam; polypropylene oxide (PPO); polystyrene (PS); polyvinylidene fluoride-trifluoroethylene (PVDF-TrFE); polyvinylidene fluoride-tetrafluoroethylene (PVDF-TFE); polybutadiene; poly(butylene terephthalate) (PBT); polycarbonate; polychloroprene; poly(cis-1,4-isoprene); polyester; poly(ether sulfone) (PES, PES/PEES); poly(ether-ether ketone)s (PEEK, PES/PEEK); polyethylene (PE); poly(ethylene glycol) (PEG); poly(ethylene terephthalate) (PET); polyethylene oxide (PEO); poly(2-hydroxymethylmethacrylate); polypropylene (PP); poly(trans-1,4-isoprene); poly (methyl acrylate); poly (methyl methacrylate); polytetrafluoroethylene (PTFE); poly(trimethylene terephthalate) (PTT); polyurethane (PU); polyvinyl butyral (PVB); polyvinylchloride (PVC); polyvinylidenedifluoride (PVDF); poly(vinyl pyrrolidone) (PVP); nylon; silicone rubbers; sodium polyacrylate; styrene-acrylonitrile resin (SAN); polymeric organosilicon; polydimethylsiloxane; and, ethylene glycol dimethacrylate.

In some embodiments, some or all of organic polymers within the organic polymer particles may be cross-linked together, preferably, covalently cross-linked together.

In some embodiments, the polymer binder comprises a polymer selected from the group consisting of: acacia gum; acrylonitrile/butadiene rubber (NBR); agarose; alginate; butyl rubber; carboxymethylcellulose; carrageenan; casein; ethylene/prolylene/diene terpolymer (EPDM); gelatin; guar gum; hydroxymethylcellulose; hydroxyethylcellulose; hydroxyl ethyl methyl cellulose; hydroxypropylcellulose (HPC); isobutylene-maleic anyhydride copolymer; ethylene-maleic anyhydride copolymer; pectin; polyethylene glycol; polyacrylnitrile; polyacrylic acid; poly(ε-caprolactone)(PLL); polyimide; polyethylene (PE); polyethyleneoxide (PEO); polyglycolide (PGA); poly(lactide); polypropylene oxide (PPO); polypropylene (PP); polyurethane; polyvinyl alcohol; neoprene; polyiosobutylene (PIB); starch; styrene/acrylonitrile/styrene (SIS) block copolymers; styrene/butadiene rubber (SBR); styrene/butadiene/styrene (SBS) block copolymers; styrene-maleic anyhydride copolymer; tragacanth: and, xanthum gum.

In some of the embodiments, some or all of the polymer binder polymer chains may be cross-linked to each other, preferably, covalently cross-linked together.

In some embodiments, the separator layer further comprises a plurality of layers, and may have one or more layers in the plurality of layers having substantially the same material composition or substantially different composition from the other of the plurality of layers.

In some embodiments, the organic polymer particles may have a tap density ranging from about 0.02 to about 0.08 g/ml, and the organic polymer particles may, when untreated, adsorb from about 6 to 9 grams of H₂O per gram of particles and adsorb from about 9 to 12 grams of oil per gram of particles. Preferably, the organic polymer particles may have a surface area (BET) of about 30 m²/g, and may have a pore volume (BET) of about 0.153 cc/g and may have a mean particle size of about 30 μm and may have an average density of about 0.03 g/cc.

In preferred embodiments, the organic polymer particles are POLYPORE™ E200™ particles by AMCOL International having a location in Lafayette, Tex., USA.

Preferably, the organic polymer particles are prepared by a suspension polymerization technique. In some embodiments, the organic polymer particles are porous and comprise cross-linked polymers resulting in a particle shape of broken spheres and sphere sections and having a median particle size diameter ranging from about 0.5 micron to about 3,000 microns. In some embodiments, the median particle size ranges from about 1 μm to about 300 μm or the median particle size ranges from about 1 μm to about 100 μm or the median particle size ranges from about 1 μm to about 80 μm or the median particle size is about 20 μm.

In highly preferred embodiments, the electrode forms part of a lithium ion battery cell having a cell chemistry, the polymer binder comprising polymers compatible with the lithium ion battery chemistry. In some embodiments, the polymer binder is substantially electrically insulating. In some embodiments, the cell may contain an electrolyte solution where the polymer binder having substantially low solubility in the electrolyte solution, and the polymer binder is substantially chemically and electrochemically stable in the cell.

In some embodiments, the separator layer may have a surface, the surface appearing substantially crack-free to the unaided human eye. In some embodiments, the organic polymer particles may have substantially irregular shape with respect to each other.

In some embodiments, the organic polymer particle comprises wax.

In some embodiments, the organic polymer particles may have a surface that has underwent a surface modification treatment imparting at least one property to the organic polymer particles different from untreated organic polymer particles. In some embodiments, the surface modification treatment improves the wettability of the untreated organic polymer particles, and/or the surface treatment grafts one or more polymer binder-like moieties to the organic polymer particle surface, and/or the organic polymer particle is coated with a coating material different from the material comprising an uncoated organic polymer particle. In some embodiments, the coating material comprises organic material, an inorganic material, or both.

In some embodiments, the organic polymer particle may further comprise a core comprising a material different from the organic polymers of the organic polymer particle or the core may comprise an inorganic material, the inorganic material may be fumed silica; porous silica; silica aerogel; pseudo-boehmite; boehmite; a boron containing compound; borax; alumina; zeolite; synthetic zeolite; and/or, ceramic.

In some embodiments, the separator layer may further comprise inorganic particles, the organic particles may comprise fumed silica; porous silica; silica aerogel; pseudo-boehmite; boehmite; a boron containing compound; borax; alumina; zeolite; synthetic zeolite; and/or, ceramic. In some embodiments, the particle may have an average cross-sectional dimension ranging from about 1 nm to 200 nm, or ranging from about 1 nm to 100 nm, or 1 nm to 80 nm, or ranging from about 20 nm to 60 nm.

In some embodiments, the organic polymer particles have a melting temperature, preferably the melting temperature ranging between 50° C. and 140° C.

In some embodiments, the organic polymer particle may contain one or more cores comprising a material different than the outer layer of the organic polymer particle, preferably where the core material is an inorganic material, preferably one or more of fumed silica; porous silica; silica aerogel; pseudo-boehmite; boehmite; a boron containing compound; borax; alumina; zeolite; synthetic zeolite; and, ceramic.

In some embodiments, the polymer binder may comprise two different types of polymer binders, each type having a melting temperature different from the other.

In some embodiments, one or more additional separator layers may be applied upon the top surface of the first separator layer, in some embodiments, at least one of the additional separator layers is different in composition than at least one of the other additional separator layers or layer, if any, or the first separator layer. In some embodiments, at least one of the additional separator layers may be the same in composition as at least one of the other additional separator layers or layer, if any, or the first separator layer.

In some embodiments, the separator may further comprise a plurality of stand-off posts for maintaining a fixed distance of separation between the electrode and a second electrode, the second electrode having a surface in contact with the separator top surface.

In another aspect, the invention provides a method for making a separator comprising; providing a first electrode having a surface, the electrode comprising: active particles; and, conductive particles; applying a coating to the surface of the electrode, the coating comprising: a plurality of organic polymer particles, each particle having a gross cross sectional dimension between 0.1 μm and 250 μm and comprising a plurality of organic polymer chains, wherein at least some of the organic polymer chains are covalently cross-linked to each other; and, a polymeric binder, wherein the plurality of organic polymer particles are embedded in the polymeric binder, wherein the coating, when formed, is substantially ion permeable and substantially electrically non-conductive.

In some embodiments, the applying step may comprise spraying the coating onto the electrode surface. In preferred embodiments, the spraying may comprise electrospraying, or the spraying may comprise powder coating, or the spraying may comprise dry spraying, or the applying step may comprise using a doctor blade applicator to apply the coating onto the electrode surface. In some embodiments, the applying step may comprise: using a slot-die applicator to apply the coating onto the electrode surface; using gravure to apply the coating onto the electrode surface; using inkjet-style printing to apply the coating onto the electrode surface; using spin coating (sometimes referred to as rotating-disk coating) to apply the coating onto the electrode surface; using electrophoretic deposition to apply the coating onto the electrode surface; using diaelectrophoretic deposition to apply the coating onto the electrode surface; using both electrophoretic and diaelectrophoretic deposition to apply the coating onto the electrode surface; using electrokinetically depositing the coating onto the surface; and/or, using screen printing to apply the coating onto the electrode surface. A sol-gel can be deposited an the carrier solvent removed by evaporation or other methods known to those of ordinary skill in the art. Centrifugal and filtration deposition may also be used.

In some embodiments, the coating may, upon application, be vibrated to cause at least some of the organic polymer particles to settle.

Some embodiments may further include a step of bonding the separator layer bottom surface to the electrode surface. In preferred embodiments, the bonding may be done by applying an adhesive to the electrode surface prior to applying the separator layer; the bonding may caused by solvent bonding, thermal bonding; and the bonding may include compression bonding; and/or the bonding may include a combination of compression and solvent bonding. In some embodiments, the bonding may include a combination of compression and thermal bonding. In some embodiments, the step of applying may include applying an adhesive layer upon the electrode surface prior to applying the coating. In preferred embodiments, the adhesive is a thermal set adhesive; the adhesive is a solvent activated adhesive.

In some embodiments, the separator layer, once formed, may be compressed against the electrode.

In some embodiments, the coating may further comprise cross-linking polymers; and the method further comprises the step of: allowing the cross-linking polymers to cross-link to the binder polymers and/or to the organic polymer particles. In some embodiments, the allowing step may further comprise exposing the separator to radio waves, microwaves, infrared light, visible light, ultraviolet light, x-ray, and gamma rays, and/or exposing the separator to heat to initiate cross-linking. In some embodiments, the allowing step may comprise adding a cross-linking initiator to the separator layer, preferably by spraying the initiator upon the top surface of the separator layer.

In some embodiments, the method may include a forming step prior to the applying step (b) to form stand-off posts upon the electrode surface.

In some embodiments, the method may include multiple applying steps to form a multilayered separator comprising a plurality of layers. In some embodiments, at least one of the separator layers may be different in at least one aspect from at least one other separator layer and/or the layers may be formed from substantially the same coating,

In some embodiments, the method may include a de-stressing step to relieve stress in the separator layer. In some embodiments, the de-stressing step relieves stress by heating the separator layer.

### BRIEF DESCRIPTION OF THE SEVERAL VIEWS OF THE DRAWING

FIG. 1 depicts a cross-sectional view of an example of a separator found in the prior art where the separator is a sheet laminated into the battery structure.

FIG. 2 depicts a cross-sectional view of an exemplary embodiment of the invention wherein the separator of the invention is situated upon an electrode.

FIG. 3 depicts a cross-sectional view of a full cell in cross-section employing an embodiment of the invention.

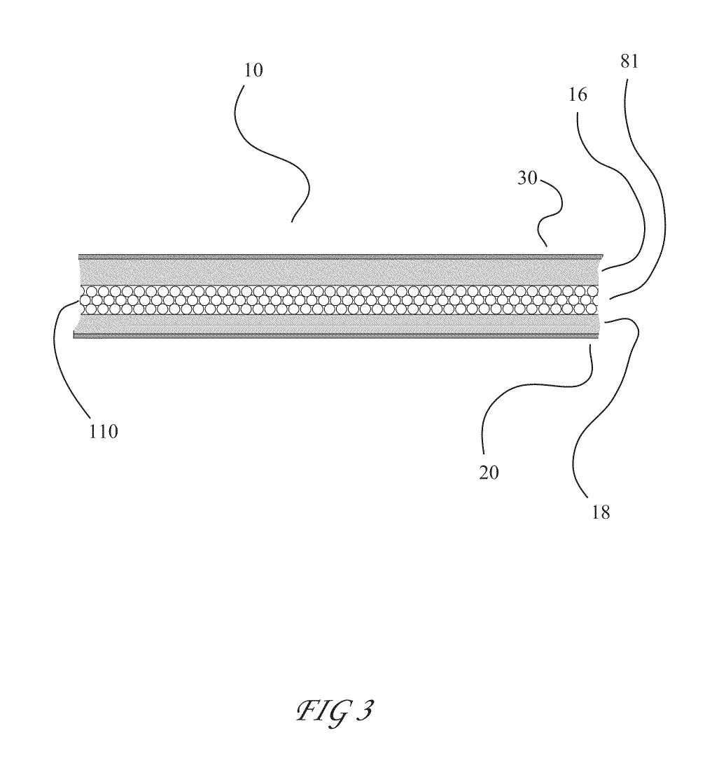

FIG. 4 depicts an embodiment of the invention wherein the separator is formed by spraying.

FIG. 5 depicts an embodiment of the invention wherein the electrodes and separator are formed by sequential spraying.

FIG. 6A and 6B depict an embodiment of the invention wherein the separator is formed using electrokinetic deposition.

FIG. 7 depicts an embodiment of the invention wherein the separator is formed in a continuous manner along a strip of electrode using electrokinetic deposition.

FIG. 8 depicts an embodiment of the invention wherein the separator comprises a layer of organic polymer particles flanked by two layers of inorganic particles.

FIG. 9 depicts an embodiment of the invention wherein the separator comprises a layer of organic polymer particles and a layer of inorganic particles.

FIG. 10 depicts an embodiment of the invention wherein the separator comprises two layers of organic polymer particles and layer of inorganic particles therebetween.

FIG. 11 depicts an embodiment of the invention wherein the separator comprises one layer of organic polymer particles flanked by two layers inorganic particles wherein the layer of organic polymer particles has melted due to thermal overrun to shut down the cell by becoming ion impermeable.

FIG. 12 depicts an embodiment of the invention wherein the separator further comprises standoffs formed by spray deposition.

FIGS. 13A and 13B depicting an embodiment of the invention that include standoffs to maintain electrode spacing when the organic polymer particles melt to shut down the cell during thermal overrun.

FIG. 14 depicts an exemplary organic polymer particle containing an inorganic particle.

FIG. 15 depicts an embodiment of a full cell containing a separator embodiment having organic polymer particles containing an inorganic particle.

FIG. 16 depicts an exemplary organic polymer particle containing a plurality of inorganic particles.

FIG. 17 depicts an embodiment of a full cell containing a separator embodiment having organic polymer particles containing a plurality of inorganic particles.

FIG. 18 depicts exemplary organic polymer particles as viewed under an electron microscope.

FIG. 19 depicts a photo image of an exemplary separator of the invention formed in-situ upon an electrode.

FIG. 20 depicts a photo image of an exemplary separator of the invention formed in-situ upon an electrode.

FIG. 21 depicts a 100× optical microscopic view of a particle separator.

FIG. 22 depicts a 1000× optical microscopic view of a particle separator.

FIG. 23 depicts exemplary organic polymer particles as viewed under an electron microscope at high magnification.

FIG. 24 depicts a photo image of an exemplary separator of the invention formed in-situ upon an electrode taken using an electron microscope.

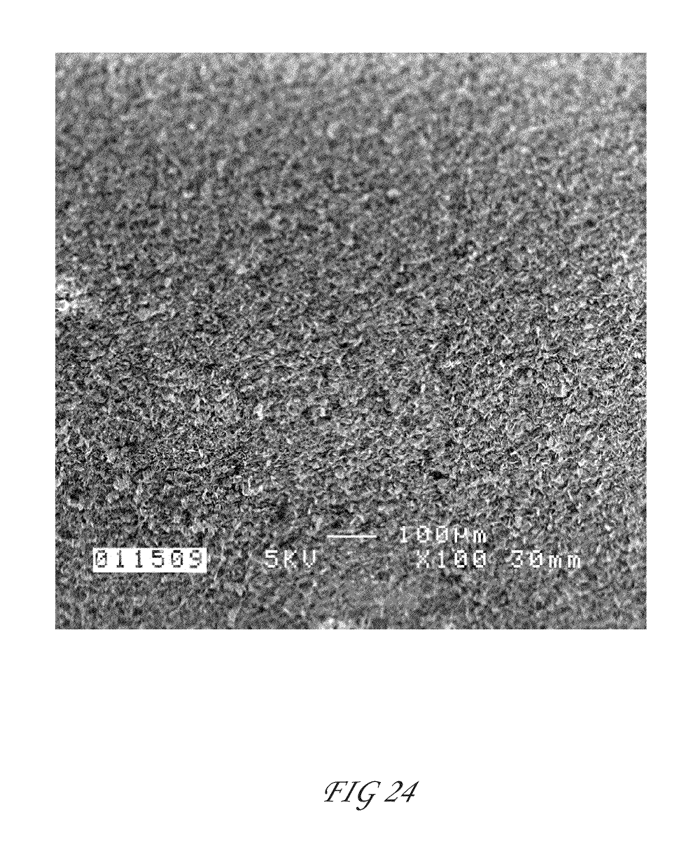

FIG. 25 depicts a voltage versus time profile for a half cell made using an exemplary separator of the invention.

FIG. 26 depicts a capacity versus number of half-cycles for a half-cell made using an exemplary separator of the invention.

FIG. 27 depicts an energy versus power profile comparing half-cells made with exemplary separators of the invention and sheet type separators.

FIG. 28 depicts an impedance profile comparing half-cells made with exemplary separators of the invention and sheet type separators.

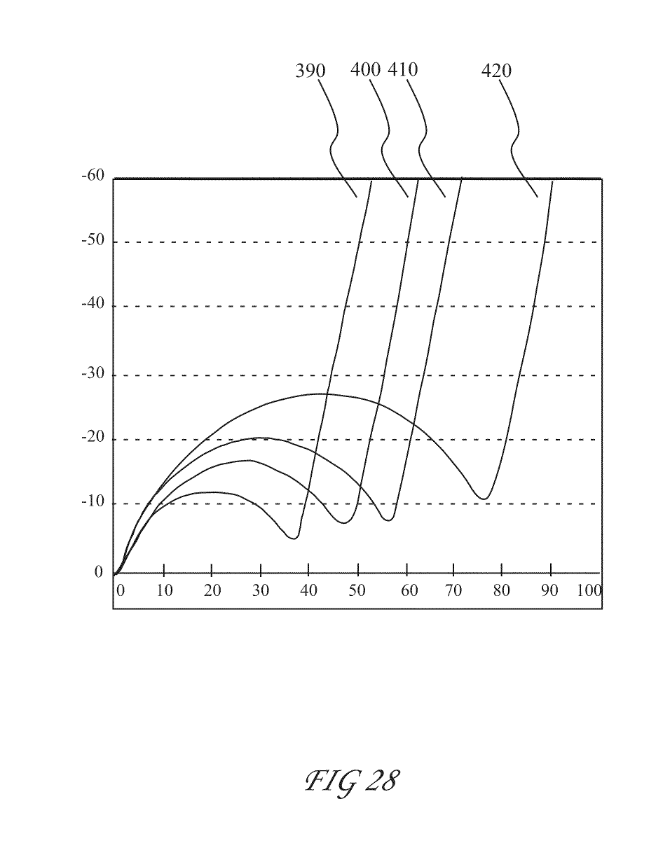

### DETAILED DESCRIPTION OF THE INVENTION

To address the needs described above, the invention provides, in one aspect, a battery electrode comprising: an electrode having a surface, the electrode comprising: a plurality of active material particles; and, a plurality of electrically conductive particles, wherein the active material particles are capable of reversibly storing ions, the active material particles and conductive particles optionally further comprising a binder material; a separator layer upon the electrode surface, the separator layer having top and bottom surfaces, the bottom surface facing the electrode surface, the separator layer comprising: a plurality of organic polymer particles, each particle having a gross cross sectional dimension between 0.1 μm and 250 μm and comprising a plurality of organic polymer chains, wherein at least some of the organic polymer chains are covalently cross-linked to each other; and, a polymeric binder, wherein the plurality of organic polymer particles are embedded in the polymeric binder.

To facilitate simple and economical manufacturing of particle separators of the invention, a method for making a separator was developed. One method takes a first electrode having a surface and comprising: active particles; and, conductive particles, and applies a coating to the surface of the electrode. The coating may comprise a plurality of organic polymer particles. Typically, each particle would have a gross cross sectional dimension ranging from 0.1 μm and 250 μm and have a plurality of organic polymer chains mixed therein. Typically, some of the organic polymer chains may be covalently cross-linked to each other; and, a polymeric binder where the organic polymer particles are embedded. The coating, when formed, may substantially be ion permeable and substantially electrically non-conductive.

To ensure a good bond between the separator and the electrode surfaces, a bonding step may be used where the separator layer bottom surface is bonded to the electrode surface. The bonding may be done by applying an adhesive to the electrode surface prior to applying the separator layer; the bonding may be caused by solvent bonding, thermal bonding; and the bonding may include compression bonding; and/or the bonding may include a combination of compression and solvent bonding. The bonding may include a combination of compression and thermal bonding. The step of applying may include applying an adhesive layer upon the electrode surface prior to applying the coating. Thermal set adhesive may be uses or the adhesive may be a solvent activated adhesive. In preferred embodiments, the adhesive layer is ion permeable and electrically conductive.

The separator layer, once formed, may be compressed against the electrode to facilitate bonding.

It may be desirable to include a de-stressing step to relieve stress in the separator layer. Typically, the de-stressing step relieves stress by heating the separator layer to partially soften the binder polymers.

Cross-linking polymers may lessen a particle's tendency to melt at a certain temperature by allowing cross-linking polymers to cross-link to the binder polymers and/or to the organic polymer particles. The allowing step may further include exposing the separator to ultraviolet light and/or exposing the separator to heat to initiate cross-linking. Another method may comprise adding a cross-linking initiator to the separator layer, preferably by spraying the initiator upon the top surface of the separator layer.

When forming a particle separator, multiple applying steps to form a multilayered separator may be desired to form a plurality of similar or different layers.

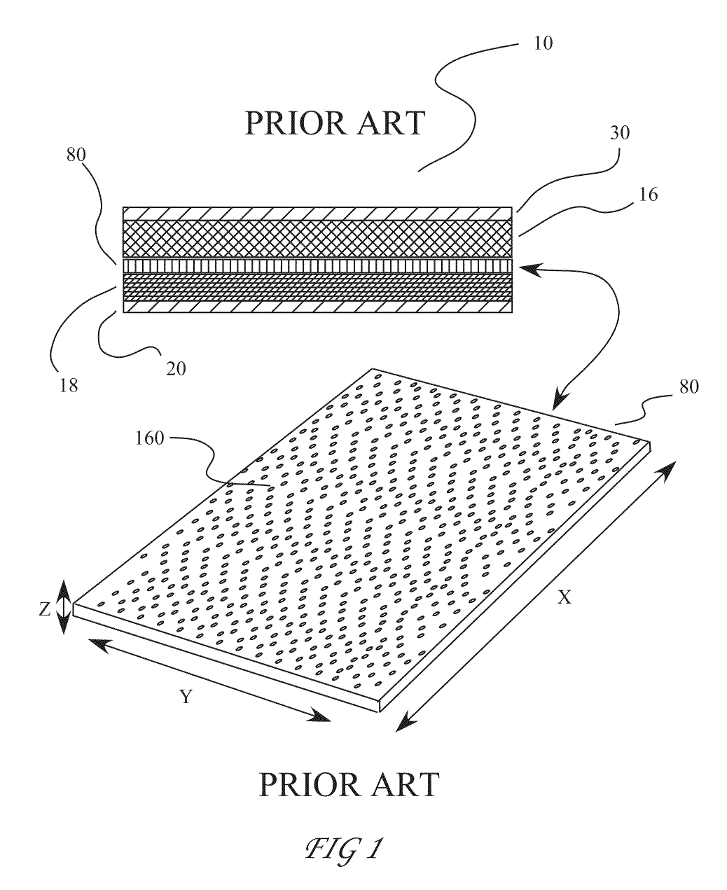

As shown in FIG. 1, the prior art provides for pre-formed sheet type battery separators. Problems exists with this design during use because the sheet has a tendency to shrink in the x and y dimensions thus allowing portions of opposing electrodes to directly contact each other and cause heating and thermal runaway. Battery Cell 10, as shown in FIG. 1, comprises two current collectors, an Anode Current Collector 20 upon which Anode 18 is situated and in electrical communication with Anode Current Collector 20. Situated adjacent Anode 18 is Separator 80, then Cathode 16, and lastly Cathode Current Collector 30 which is in electrical communication with Cathode 16.

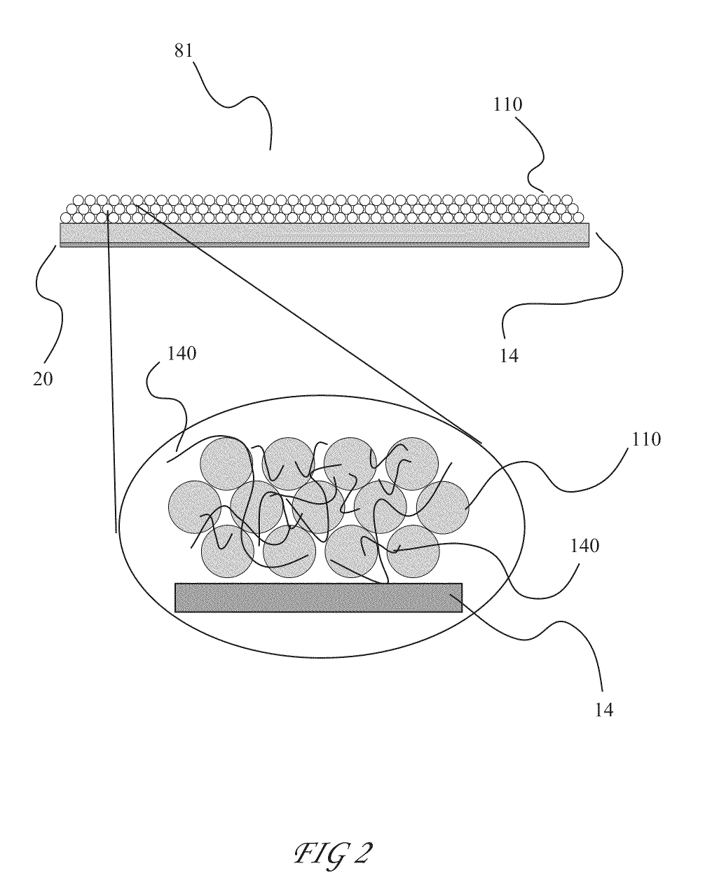

Applicants have discovered that forming a separator in-situ, or in some instances, ex-situ by first forming the particle separator on a transfer sheet, then transferring the formed particle separator to an electrode surface, and then removing the transfer sheet and assembling the rest of the cell. By applying particles to the surface of an electrode offers superior performance over the sheet separators of the prior art. An exemplary embodiment of the invention is shown in FIG. 2 where Particle Separator 81 has been formed upon Electrode 14 that is in electrical communication with Current Collector 20. The enlargement view of FIG. 2 shows close-up the Organic Polymer Particles 110 with Polymer Binders 140 entangled and binding together OPP 110.

Variations of the invention may include the organic polymer particles being porous or non-porous, or a mixture of porous and non-porous particles. The separator layer may comprises pores having a pore diameter and that are permeable to lithium ions, the separator being substantially not electrically conductive.

The separator layer may have pores having a monomodal pore size distribution ranging from about 5 nm to 500 nm or a bimodal pore size distribution, the first mode ranging from about 5 nm to 100 nm, and the second mode ranging from about 100 nm to about 500 nm.

To maintain the structural integrity of the particle separator, a polymeric binder that is electrochemically compatible with materials found within lithium ion cells may be used to bind together the particles in the particle separator.

Organic polymer particles may have a cross-sectional dimension ranging from about 1 and 10 nm or ranging from about 10 and 50 nm or ranging from about 10 and 100 nm or ranging from about 20 and 2000 nm or ranging from about 1 μm and 10 μm or ranging from about 0.05 μm and 10 μm or ranging from about 1 μm and 100 μm.

The porous polymer organic polymer particles have an average porosity ranging from about 10% to 95% or ranging from about 40% to 95% or ranging from about 20% to 80% or ranging from about 30% to 80% or ranging from about 40 to 80%.

The organic polymer chains may comprise substantially the same type of organic polymer chains or the organic polymer chains comprise at least two or more different types of polymer chains. By way of non-limiting example, the organic polymer chains may comprise any one or combination of polymers selected from the from the following group including, but not limited to, acrylonitrile butadiene styrene (ABS); allylmethacrylate; polyacrylonitrile (PAN) or acrylic; polyamide; polyaramides; polybutadiene; poly(butylene terephthalate) (PBT); polycarbonate; polychloroprene; poly(cis-1,4-isoprene); polyester; poly(ether sulfone) (PES, PES/PEES); poly(ether-ether ketone)s (PEEK, PES/PEEK); polyethylene (PE); poly(ethylene glycol) (PEG); poly(ethylene terephthalate) (PET); polyethylene oxide (PEO); poly(2-hydroxymethylmethacrylate); polypropylene (PP); poly(trans-1,4-isoprene); poly (methyl acrylate); poly (methyl methacrylate); polytetrafluoroethylene (PTFE); poly(trimethylene terephthalate) (PTT); polyurethane (PU); polyvinyl butyral (PVB); polyvinylchloride (PVC); polyvinylidenedifluoride (PVDF); poly(vinyl pyrrolidone) (PVP); nylon; silicone rubbers; sodium polyacrylate; styrene-acrylonitrile resin (SAN); polymeric organosilicon; polydimethylsiloxane; and, ethylene glycol dimethacrylate.

The polymer binder, if used, may comprises one or more polymers selected from the non-limiting group of polymers that include, but are not limited to, acrylonitrile/butadiene rubber (NBR); agarose; alginate; butyl rubber; carboxymethylcellulose; casein; ethylene/prolylene/diene terpolymer (EPDM); gelatin; guar gum; hydroxymethylcellulose; hydroxyethylcellulose; hydroxyl ethyl methyl cellulose; hydroxypropylcellulose; isobutylene-maleic anyhydride copolymer; ethylene-maleic anyhydride copolymer; pectin; polyethylene glycol; polyacrylnitrile; polyacrylic acid; polyimide; polyurethane; polyvinyl alcohol; neoprene; polyiosobutylene (PIB); starch; styrene/acrylonitrile/styrene (SIS) block copolymers; styrene/butadiene rubber (SBR); styrene/butadiene/styrene (SBS) block copolymers; styrene-maleic anyhydride copolymer; and, xanthum gum.

Often, it may be desirable to have the separator layer further include a plurality of layers, and may have each layer in the plurality of layers be substantially the same material composition or substantially different composition from the other of the plurality of layers.

Organic polymer particles may have a tap density ranging from about 0.02 to about 0.08 g/ml, and the organic polymer particles may, when untreated, adsorb from about 6 to 9 grams of H₂O per gram of particles and adsorb from about 9 to 12 grams of oil per gram of particles. Preferably, the organic polymer particles may have a surface area (BET) of about 30 m²/g and may have a pore volume (BET) of about 0.153 cc/g and may have a mean particle size of about 30 μm and may have an average density of about 0.03 g/cc.

The examples of the invention may include POLYPORE™ E200™ particles as the organic polymer particles. POLYPORE™ particles are sold by AMCOL International having a location in Lafayette, Tex., USA.

The organic polymer particles may be prepared by a suspension polymerization technique. In some embodiments, the organic polymer particles are porous and comprise cross-linked polymers resulting in a particle shape of broken spheres and sphere sections and having a median particle size diameter ranging from about 0.5 micron to about 3,000 microns. The median particle size ranges from about 1 μm to about 300 μm or the median particle size ranges from about 1 μm to about 100 μm or the median particle size ranges from about 1 μm to about 80 μm or the median particle size is about 20 μm.

The electrode may form part of a lithium ion battery cell being of a type of lithium ion chemistry, and the polymer binder may comprise polymers compatible with the lithium ion chemistry. Typically, the polymer binder is substantially electrically insulating and the cell may contain an electrolyte solution where the polymer binder has substantially low solubility in the electrolyte solution. The polymer binder may be substantially chemically and electrochemically stable in the cell.

Usually, the separator layer may have a surface appearing substantially crack-free to the unaided human eye. The organic polymer particles may also have substantially irregular shape with respect to each other. In certain cases, the organic polymer particle may comprises wax or wax particles.

The organic polymer particles may have a surface that has underwent a surface modification treatment imparting at least one property to the organic polymer particles different from untreated organic polymer particles. Surface modification treatment generally performed to improve the wettability of the untreated organic polymer particles, and/or the surface treatment may graft one or more polymer binder-like moieties to the organic polymer particle surface. The organic polymer particle may be coated with a coating material or may comprise an uncoated organic polymer particle. The coating material may comprise organic material, an inorganic material, or both.

The organic polymer particle may include one or more cores that may comprise a material different from the organic polymers of the organic polymer particle. Alternatively, the core may comprise an inorganic material. Non-limiting examples of inorganic material may be fumed silica; porous silica, et al; silica aerogel; pseudo-boehmite; boehmite; a boron containing compound; borax; alumina; zeolite; synthetic zeolite; and/or, ceramic.

The separator layer may include inorganic particles. Non-limiting examples of the organic particles include, but are not limited to, fumed silica; porous silica; silica aerogel; pseudo-boehmite; boehmite; a boron containing compound; borax; alumina; zeolite; synthetic zeolite; and/or, ceramic. The particle may have an average cross-sectional dimension ranging from about 1 nm to 200 nm, or ranging from about 1 nm to 100 nm, or 1 nm to 80 nm, or ranging from about 20 nm to 60 nm.

It may be desirable to have the organic polymer particles melt at a certain temperature, perhaps to impart a “shutdown” nature to the particle separator where when a predetermined temperature is reached, the ion permeability of the particle separator is substantially reduced or eliminated. The organic polymer particles or polymer binders may have a melting temperature, preferably the melting temperature ranging from about 50° C. to about 140° C. In other embodiments, the melting temperature may range from about 70° C. to about 80° C.

The organic polymer particle may contain one or more cores of a material different than the outer layer of the organic polymer particle. The core material may be an inorganic material. The inorganic material may be one or more of the non-limiting materials, including, but not limited to, fumed silica; porous silica; silica aerogel; pseudo-boehmite; boehmite; a boron containing compound; borax; alumina; zeolite; synthetic zeolite; and, ceramic.

The polymer binder may comprise two different types of polymer binders, each type having a melting temperature different from the other.

When incorporated into Battery Cell 10, the OPP sandwiched between Anode 18 and Cathode 16 and acting as a physical separator to prevent Cathode 16 and Anode 18 from contacting each other and potentially causing thermal runaway.

The applying step may comprise spraying the coating onto the electrode surface. The spraying may include, but not be limited to, electrospraying, powder coat spraying, or dry spraying. Other methods of applying the particles to form a particle separator may include, but are not limited to, using a doctor blade applicator to apply the coating onto the electrode surface. Other variants include, but are not limited to, using a slot-die applicator to apply the coating onto the electrode surface; using gravure to apply the coating onto the electrode surface; using inkjet-style printing to apply the coating onto the electrode surface; using spin coating to apply the coating onto the electrode surface; using electrophoretic deposition to apply the coating onto the electrode surface; using diaelectrophoretic deposition to apply the coating onto the electrode surface; using both electrophoretic and diaelectrophoretic deposition to apply the coating onto the electrode surface; using electrokinetically depositing the coating onto the surface; and/or, using screen printing to apply the coating onto the electrode surface. The coating, once applied but prior to setting, may be vibrated to cause at least some of the organic polymer particles to stratify from each other based on a property of the particles, for example, but not limited to, density, size, porosity, and shape.

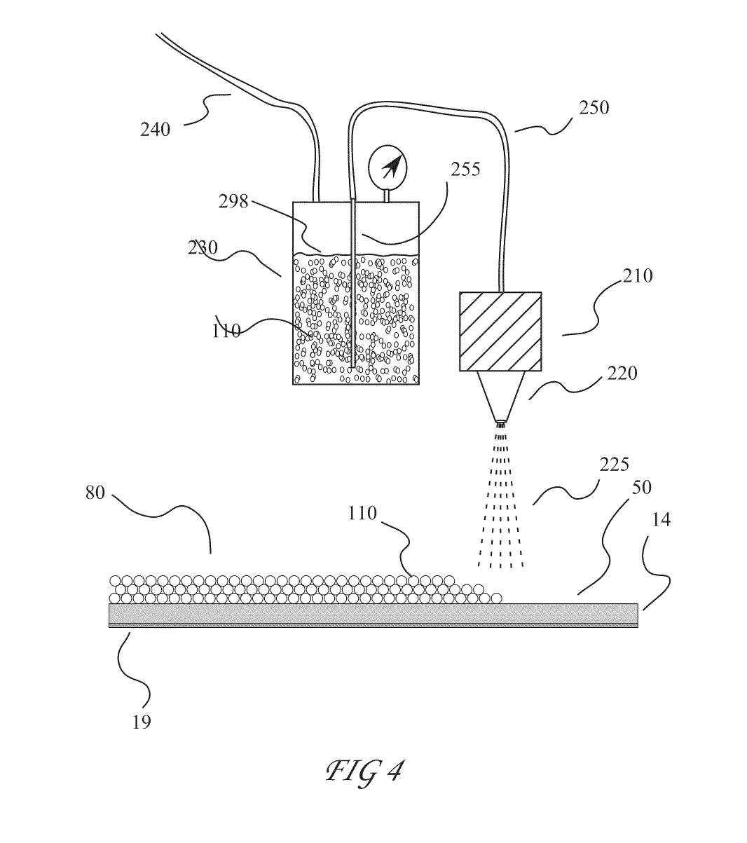

The invention provides for methods for making the separators of the invention. FIG. 4 shows Particle Separator 81 being formed using a spray method. Sprayer 210 is fed via Suspension Feed Line 250 Suspension 298 with OPP 110 contained in Vessel 230 with Suspension Feed Tube 225. Gas pressure is supplied to Vessel 230 via Pressurized Gas Supply Line 240. When activated, Sprayer 210 sprays Suspension 298 through Spray Tip 220 to apply OPP 110 to Surface 50 of Electrode 14 to form Particle Separator 81.

In some embodiments, the current collector is coated with an electrically conductive adhesive to improve bonding of the electrode to the current collector.

In some embodiments, the separator is bonded to the electrodes using an ionically conductive adhesive.

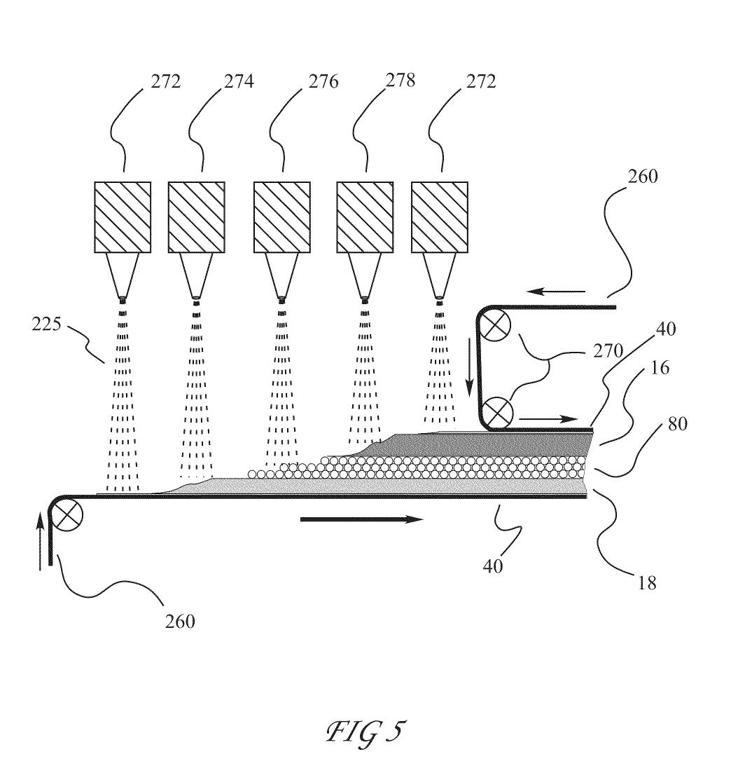

A highly preferred embodiment forms complete cells using a system as depicted in FIG. 5. The process shown in FIG. 5 produces complete cell laminates in a constant roll-to-roll process. Roll Stock Current Collector 260 is unwound from a reel, not shown, and is directed to a series of spray regions, or spray/dry regions by Rollers 270. The first coating depicted in FIG. 5 is Conductive Adhesive Layer 40 sprayed from Adhesive Sprayer 274, which is then coated with Anode 18 from Anode Material Sprayer 272, then Particle Separator 81 from Separator Material Sprayer 276, followed by Cathode 16 deposited from Cathode Material Sprayer 278, then Second Conductive Adhesive Layer 42 deposited from Adhesive Sprayer 272. Lastly, Second Roll Stock Current Collector 262 is applied to the exposed side of Second Adhesive Layer 42 adjacent Cathode 16. Again, Rollers 270 are used to guide Second Roll Stock Current Collector 262 onto Second Adhesive Layer 42.

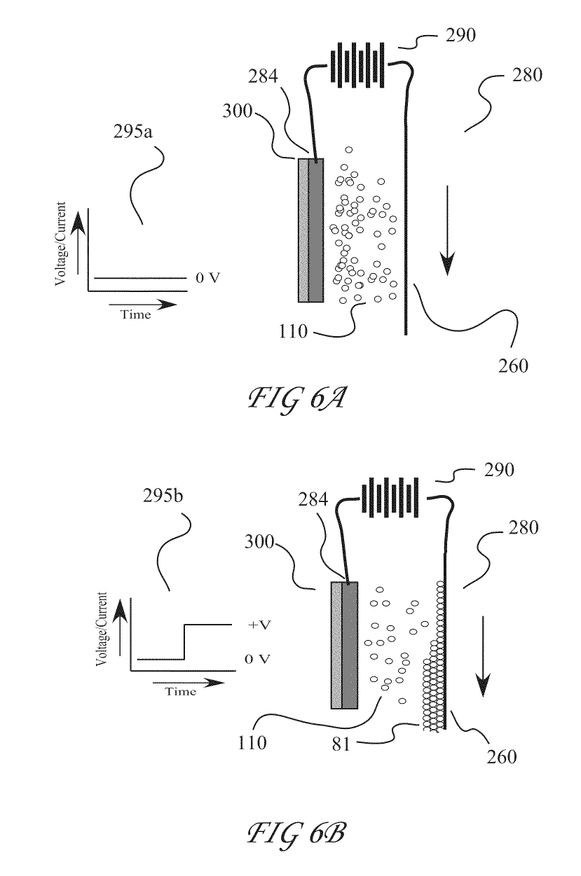

The invention also provides alternate particle deposition methods. For example, but not limited to, electrophoretic deposition. FIG. 6A depicts an exemplary electrophoretic deposition process where Roll Stock Current Collector 260 is directed through a suspension in the presence of an electrical field established between Roll Stock Current Collector 260 via Contact 320 and Counter Electrode 284 adjacent Insulator 300. Power Supply 290 is in electrical communication with Contact 320 and Counter Electrode 284 to complete and energize the circuit. OPP 110 are motivated by the electric field to move towards Roll Stock Current Collector 260 and deposit thereupon to form Particle Separator 81. Graphs 295A and 295B depict the voltage or current bias applied between Counter Electrode 284 and Roll Stock Current Collector 260. As OPP 110 are deposited, Roll Stock Current Collector 260 is advanced to expose un-deposited surface to the electric field while newly formed Particle Separator 81 is moved out of the electric field.

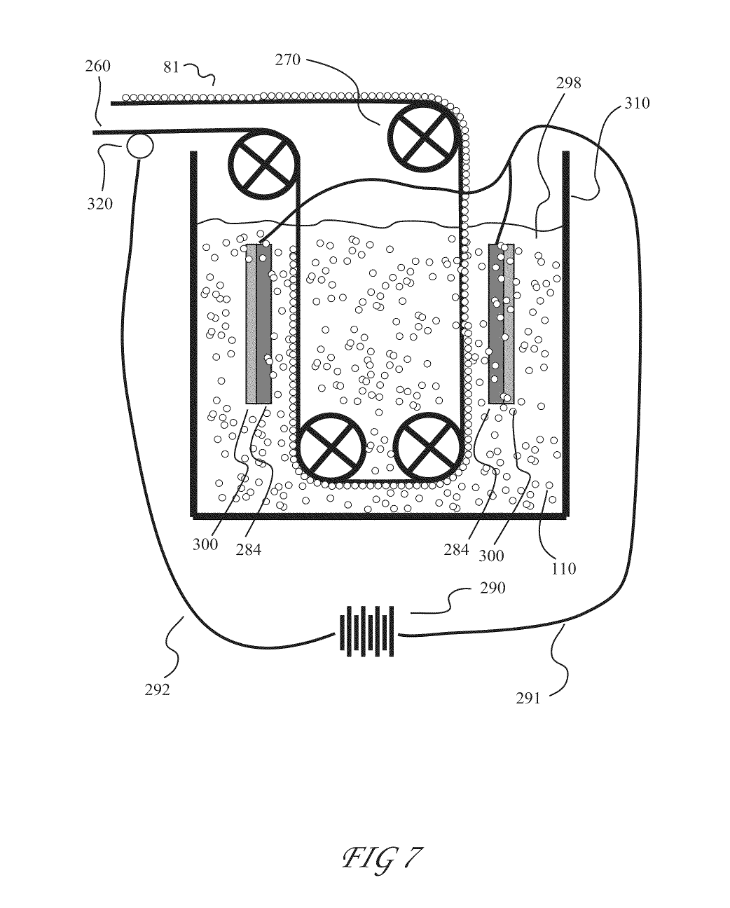

An exemplary deposition method and apparatus is depicted in FIG. 7 wherein Tank 310 contains Suspension 298 as well as two Counter Electrodes 284, each adjacent Insulator 300. Counter Electrodes 284 are in electrical communication with Power Supply 290 via Negative Lead 291. Contact 320 is in electrical communication with Power Supply 290 via Positive Lead 292 to energize Roll Stock Current Collector 260 and create an electric field between Counter Electrodes 284 and Roll Stock Current Collector 260 while submerged in Suspension 298. As Roll Stock Current Collector 260 is directed through Suspension 298 in Tank 310 by Rollers 270. During deposition, OPP 110 are deposited onto Roll Stock Current Collector 260 to form Particle Separator 81 in a continuous fashion. Suspension 298 is replenished by circulating Suspension 298 between Tank 310 and a replenishment/supply/mixer tank, not shown.

In some embodiments, one or more additional separator layers may be applied upon the top surface of the first separator layer, in some embodiments, at least one of the additional separator layers is different in composition than at least one of the other additional separator layers or layer, if any, or the first separator layer. In some embodiments, at least one of the additional separator layers may be the same in composition as at least one of the other additional separator layers or layer, if any, or the first separator layer.

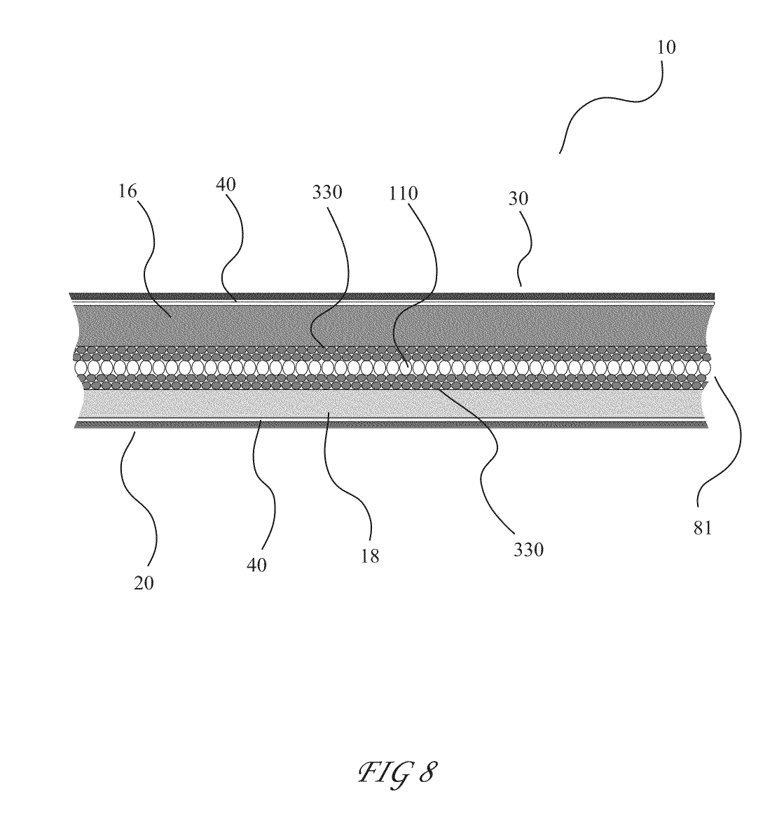

An exemplary Battery Cell 10 is shown in FIG. 8 where Particle Separator 81 comprises OPP 110 and Inorganic Particles 330 in a tri-layer formation separating Anode 18 from Cathode 16. Here, a layer of OPP 110 is flanked by layers comprising Inorganic Particles 330. In this configuration , the OPP 110 layer is ion-permeable because OPP 110 are discrete particles have gaps therebetween wherein the ions may pass. In some embodiments, ions may pass through OPP 110 if such is porous to ions. In some embodiments, ions may pass through Particles 330 Upon heating during an overload condition, OPP 110 melt together at a predetermined temperature to form a monolithic layer that is ion impermeable. Inorganic Particles 330 remain discrete at the OPP 110 melting temperature and serve to prevent Anode 18 and Cathode 16 from contacting each other directly. The OPP 110 layer may penetrate into the layers comprising Inorganic Particles 330 to form an ion-impermeable aggregate of OPP 110 residue and Inorganic Particles 330.

In some embodiments, the separator further comprises thermal shutdown properties wherein the separator becomes substantially non-ionically permeable upon exceeding a predetermined temperature. In some embodiments, the thermal shutdown property is due to the melting of an organic polymer particle. In some embodiments, the thermal shutdown property is due to the melting of a polymer binder. In some embodiments, the organic polymer particles further comprise an inorganic particle entrapped therein. In some embodiments, the inorganic particle is a plurality of inorganic particles entrapped within each organic polymer particle.

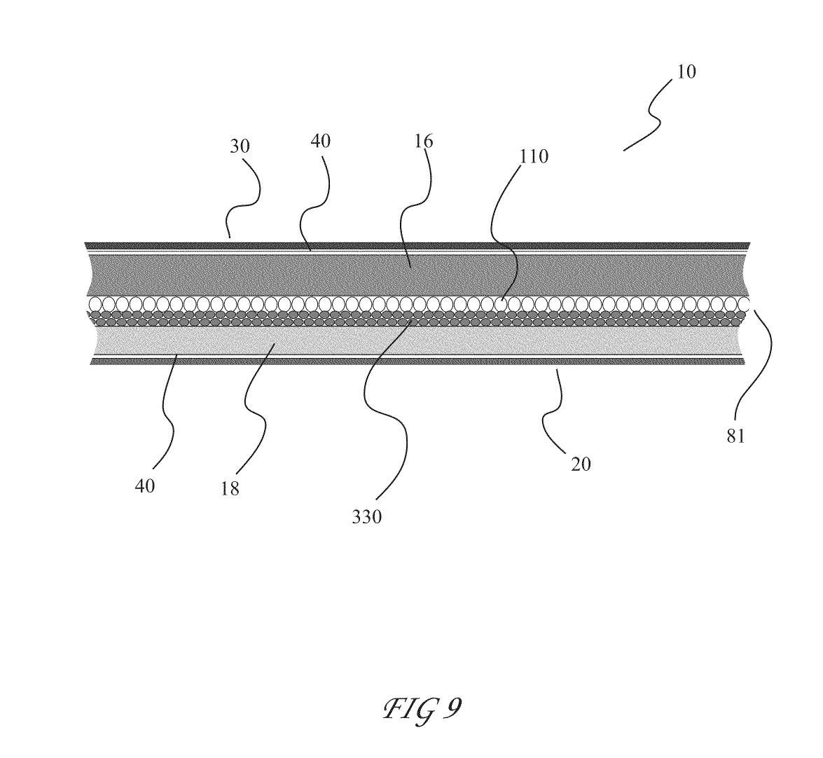

A two layer Particle Separator 81 is shown in FIG. 9. Here, Battery Cell 10 comprises the same components as shown in FIG. 8, however, only one layer of Inorganic Particles 330 and one layer of OPP 110 comprise Particle Separator 81. Upon reaching the melting temperature of OPP 110, the OPP 110 ion-impermeable layer may form distinct from Inorganic Particles 330 or may melt into and permeate Inorganic Particles 330 layer to form a ion-impermeable aggregate layer comprising Inorganic Particles 330 surrounded by OPP 110 residue.

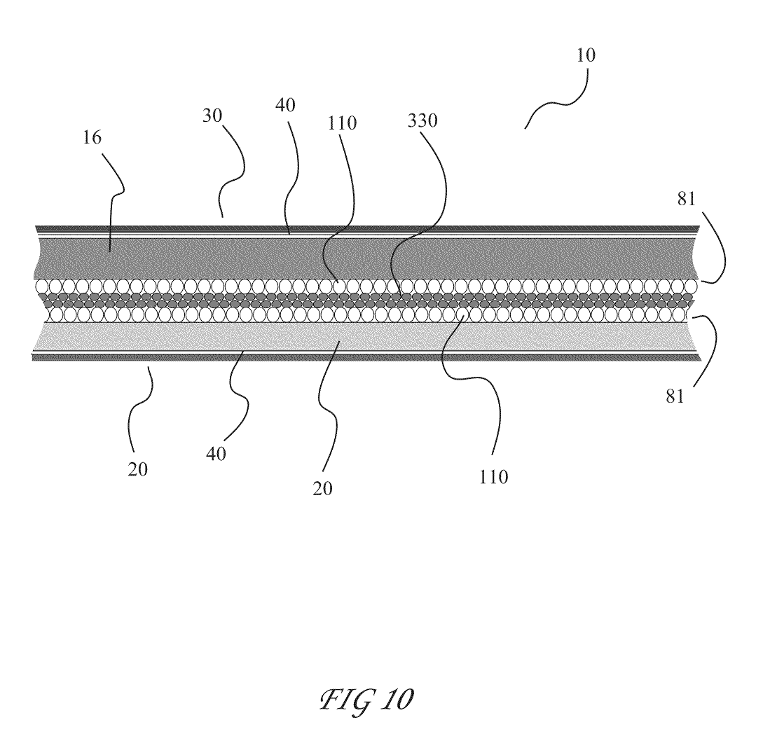

Another variation of Particle Separator 81 is shown in FIG. 10 where Inorganic Particles 330 form a layer that is flanked by layers comprising OPP 110. As described above, OPP 110 may melt to form a layer distinct from Inorganic Particles 330 or melt into Inorganic Particles 330 layer to form an ion-impermeable aggregate layer.

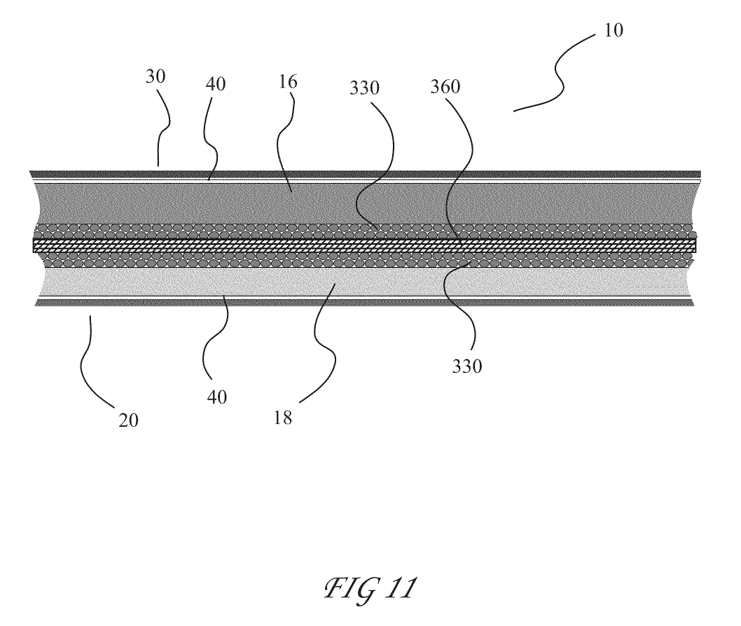

FIG. 11 shows Melt Formed Barrier 360 that formed upon the melting of OPP 110, not shown, to form an ion-impermeable layer.

In some embodiments, the separator may further comprise a plurality of stand-off posts for maintaining a fixed distance of separation between the electrode and a second electrode, the second electrode having a surface in contact with the separator top surface.

In some embodiments, the method may include a forming step prior to the applying step (b) to form stand-off posts upon the electrode surface.

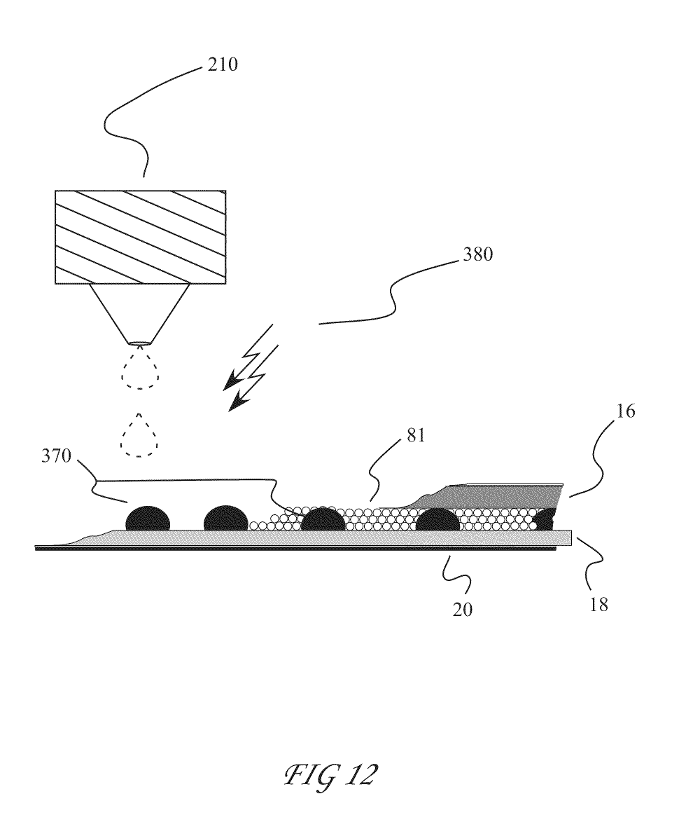

An alternative to using inorganic particles to maintain separator distance after the organic polymer particles have melted during overheating is to use standoffs. FIG. 12 shows a spraying setup similar to that shown in FIG. 5 except that Standoff Sprayer 210 is added to the line to form Standoffs 370 in a spatially distributed manner wherein OPP 110 are deposited between, and optionally upon too, Standoffs 370. In certain embodiments, Standoffs 370 may be solidified by exposure to an external energy source such as heat, or as shown in FIG. 12, Light 380 to initiate cross-linking of polymers within Standoff 370 to form a rigid Standoff 370.

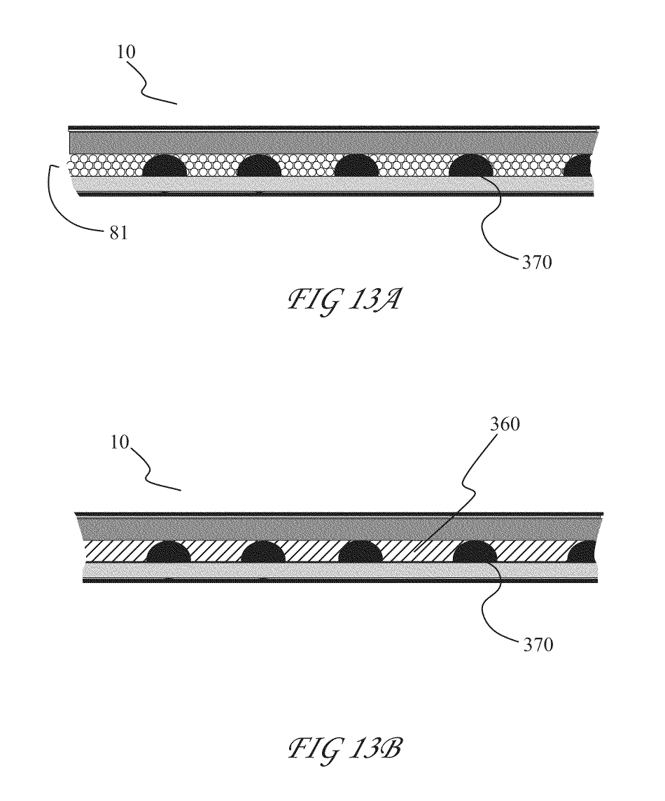

Battery Cell 10 with Standoffs 370 and OPP 110 therebetween is shown in a pre-melt state (FIG. 13A) and melt state (FIG. 13B) where Melt Formed Barrier 360 is shown.

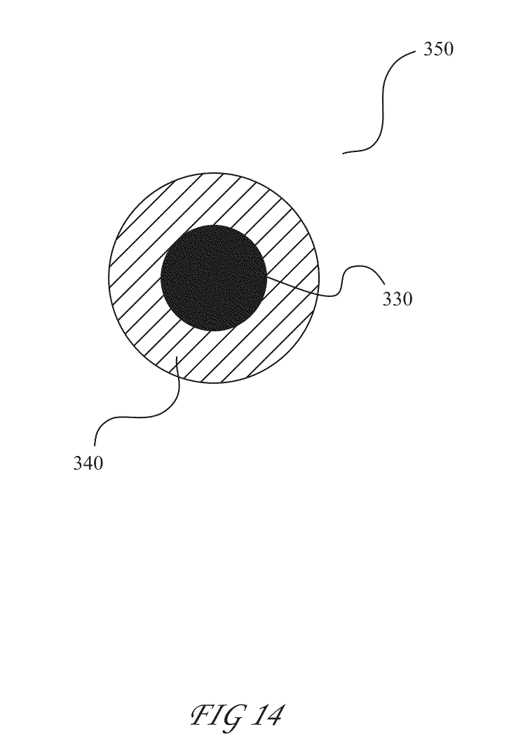

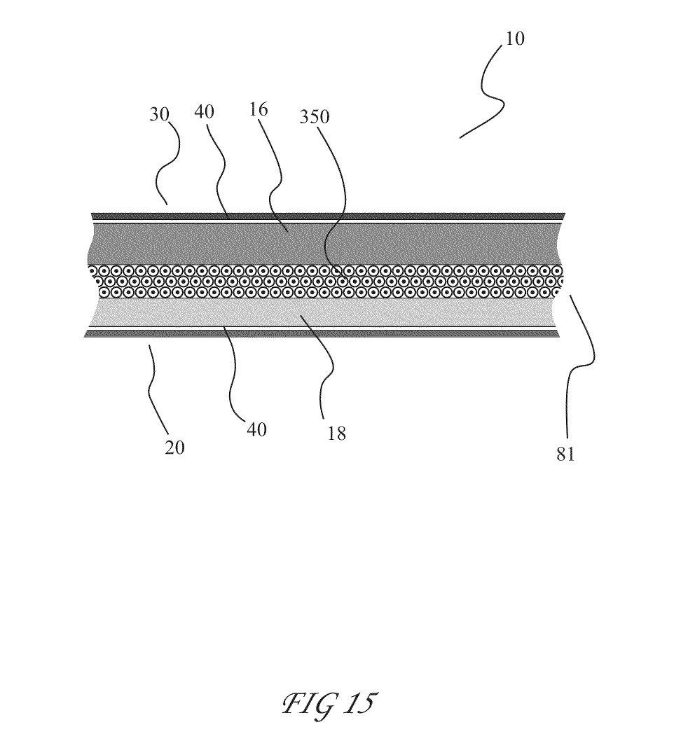

In some embodiments, organic polymer particles may further comprise one or more inorganic particles in each organic polymer particle. FIG. 14 shows an exemplary Coated Particle 350 where OPP 110 containing an Inorganic Particle 330 as a core. FIG. 15 shows the incorporation of Coated Particles 350 into Particle Separator 81. The advantage being a single layer particle separator instead of having to form two or three distinct layers. As an alternative, inorganic particles and organic polymer particles may be simultaneously deposited to form a particle separator comprising inorganic and organic polymer particles in one layer.

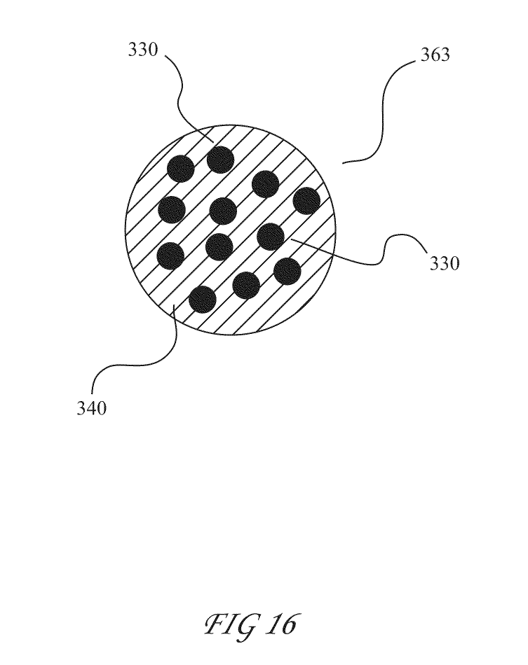

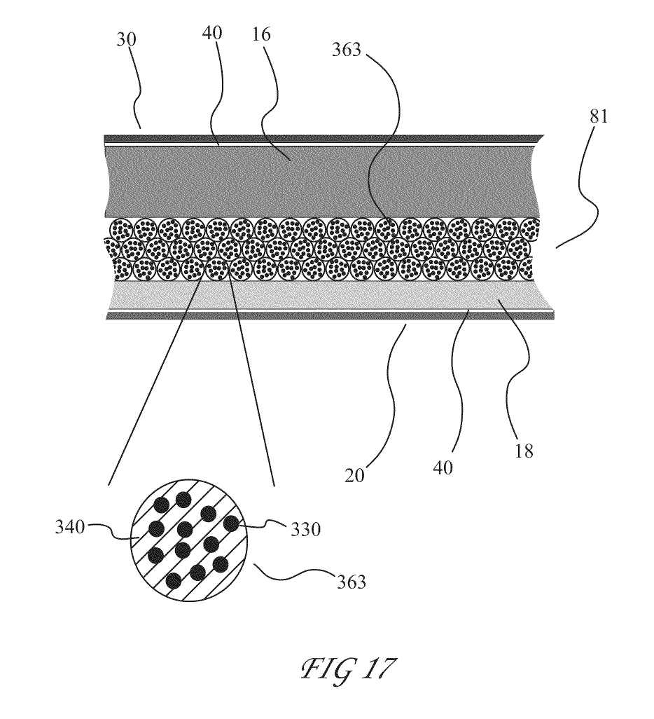

FIG. 16 shows a variation of Coated Particle 360 shown in FIG. 14 wherein a plurality of Inorganic Particles 330 are embedded in a single OPP 110 to form Coated Particles 363. FIG. 17 shows Particle Separator 110 formed from Coated Particles 363.

When incorporated into Particle Separator 81, Coated Particles 363 act both to prevent unwanted contact between electrodes and to establish Melt Formed Barrier in the event of thermal overload thus ionically isolating Cathode 16 from Anode 18 as shown in FIG. 17.

### EXAMPLES

### Example 1

### Organic Polymer Particles

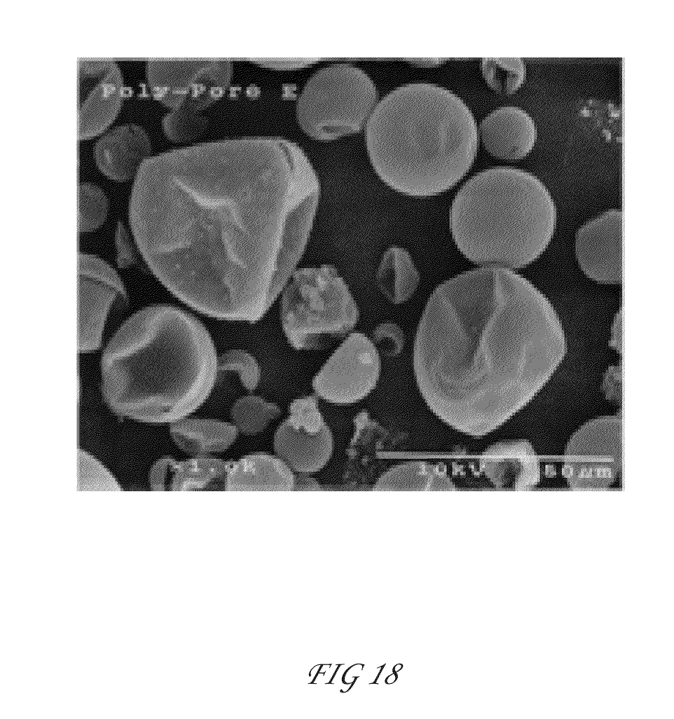

Commercially available, organic polymeric particles, POLYPORE™ by AMCOL Health and Beauty Solutions, Inc., Hoffman Estates, Ill., USA, were used in the following examples. The POLYPORE™ particles comprise allyl methacrylate cross-linked polymer. The particles appear as broken and collapsed spheroids and demonstrate high levels of porosity when characterized. Because the particles are cross-linked, they acted as spacers between the two electrodes. Cross-linked polymers typically combust rather than melt. For organic polymer particles used in the “shutdown” embodiments of the invention, similar, yet un-cross-linked, polymer particles would be used instead. An electron micrograph of POLYPORE™ particles is shown in FIG. 18. The micrograph was obtained from the AMOCOL website and Inventors claim no copyright therein.

### Example 2

### Forming Particle Separators

To form the coating suspension, 24 mg of dry POLYPORE™ particles having an average cross-sectional dimension ranging from about 5 μm to 15 μm, having a bulk density of about 0.035 g/cc and a tap density of about 0.055 g/cc were dispersed in 20 ml of water. To the suspension was added 3 mg of the binder polyethyleneoxide (PEO).

To coat a prepared electrode comprising nanosized silicon particles/carbon nanotubes/binder, a standard artist's airbrush was used with an air pressure of about 20 PSI and a spray distance of about 6 to 10 inches. The suspension was applied with repeated back-and-forth motions at a rate that resulted in the region previously coated appearing dry before spraying over the region again. Once fully coated by visual observation, the electrode with particle separator was left to dry in ambient conditions.

### Example 3

### Electrode Formation Using EPD

To form the coating suspension, 24 mg of dry POLYPORE™ particles having an average cross-sectional dimension ranging from about 5 μm to 15 μm, having a bulk density of about 0.035 g/cc and a tap density of about 0.055 g/cc were dispersed in 20 ml of 200 proof ethanol. To the suspension was added 3 mg of the binder PEO and about 5 mg Mg(NO₃)₂ to act to give charge to the particles by entrapping the Mg⁺⁺ ions which impart electrophoretic mobility to the particles during electrophoretic deposition. The suspension was mixed by water bath ultrasonication for about 30 minutes and brought to a final volume of 60 ml by the addition of ethanol.

The suspension was added to a small square tank having on one side wall a sheet of graphite affixed thereto. A small sheet of copper foil (1″×3″) clamped to a glass microscope slide was immersed into the tank and clamped to the side wall opposite the tank. Electric leads were clamped to the counter-electrode (+) and the copper foil (−) and connected to a constant current power supply. A DC electric field was established at a constant current rate of about 80 milliamps for 30 seconds intervals (8 total) with intervening ultrasonication of the suspension in another container to break-up particle clusters and aggregates, then reintroduced into the tank. After completion of the deposition steps, the newly formed particle separator was allowed to dry under ambient conditions.

### Example 3

### Imagery of Formed Particle Separators

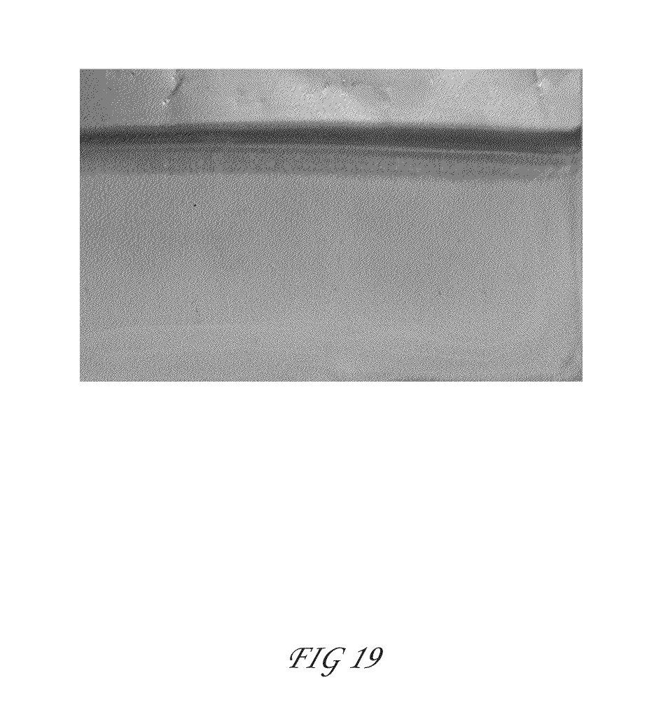

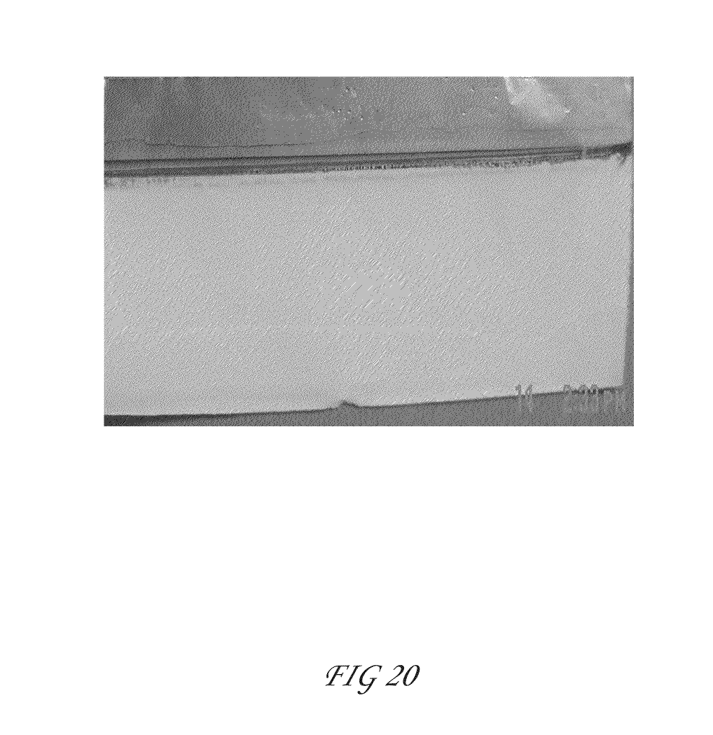

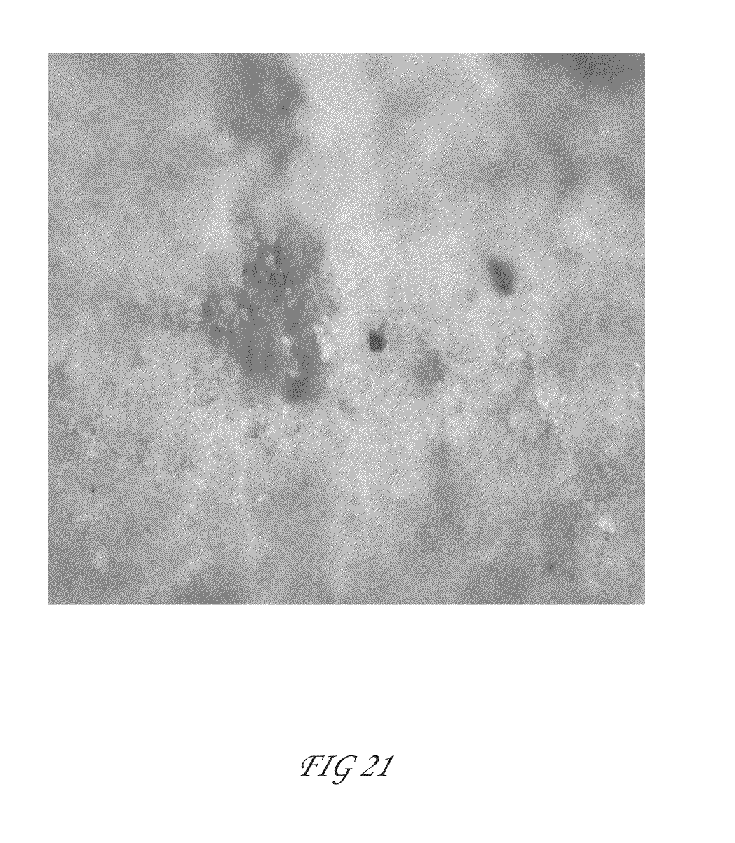

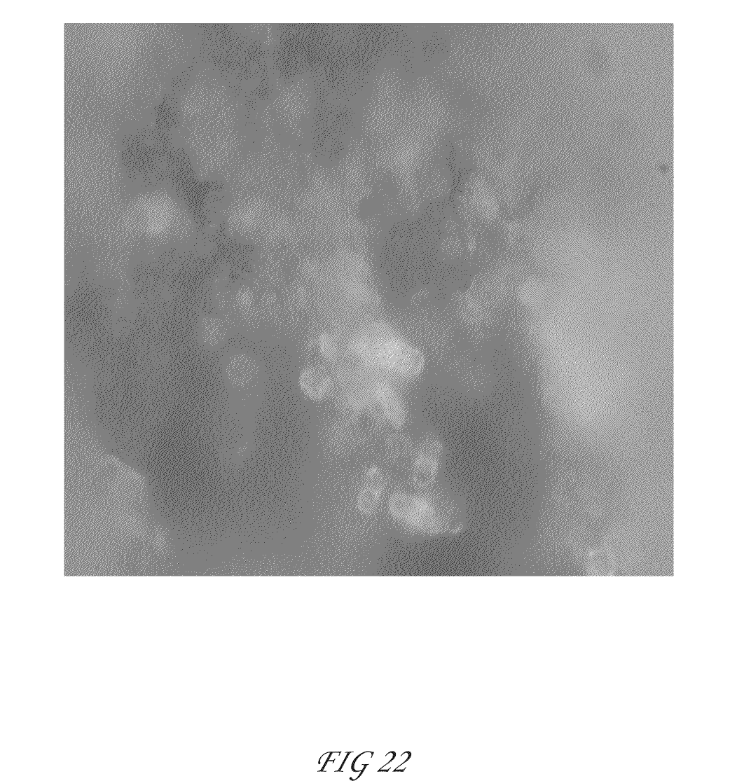

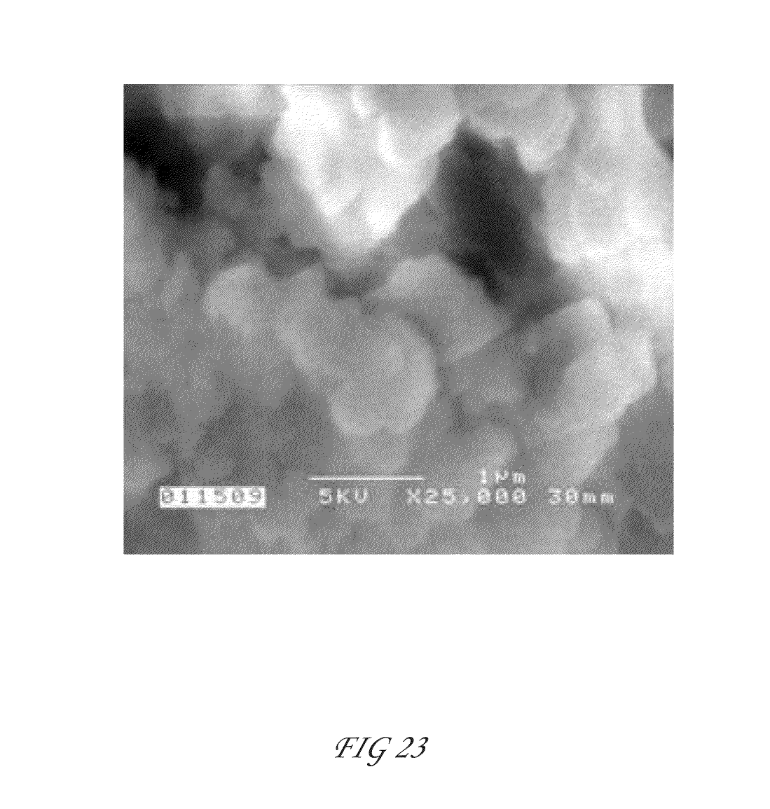

Standard digital photography revealed, as shown in FIGS. 19 and 20, well-formed, contiguous appearing layers having a smooth appearance to the eye. Closer examination using optical microscopy revealed, as shown in FIGS. 21 and 22, that the POLYPORE™ particles retain their approximate original shape and appeared bound together forming small peaks and valleys. Inter-particle gaps indicated that the ionic porosity of the particle separator was due, perhaps in-part, by the spaces between the particles, and possibly also due to the particle porosity as well. Electron microscopy showed tight bundling of the particles in tufts with tortuous voids between clusters as shown in FIGS. 22 and 23.

### Example 4

### Functional Electrical Testing of Electrodes

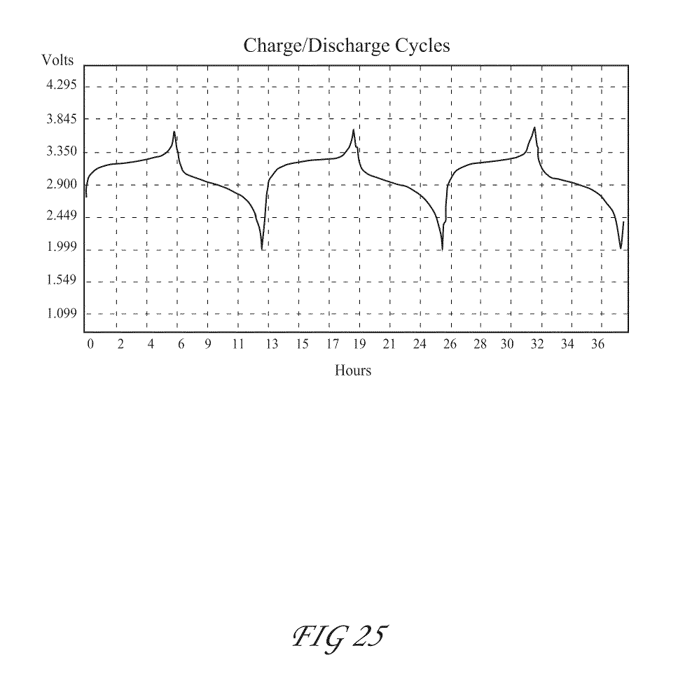

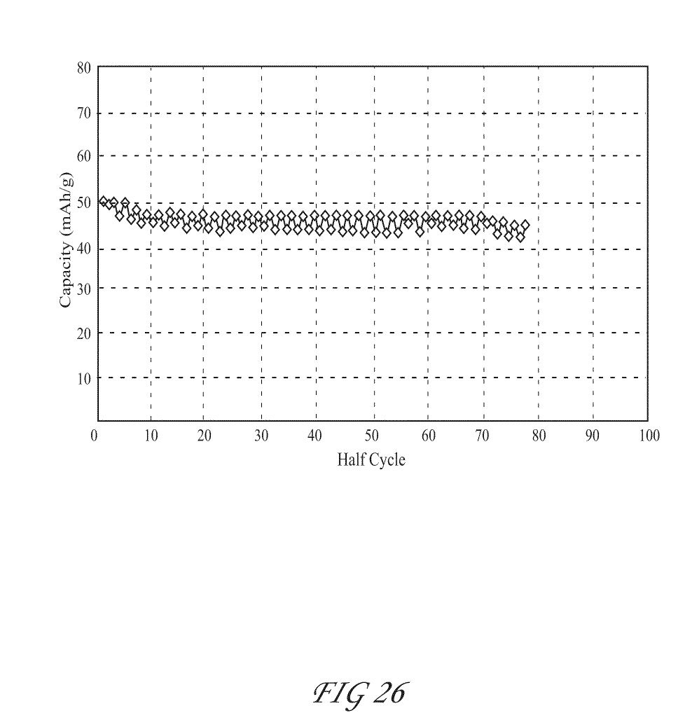

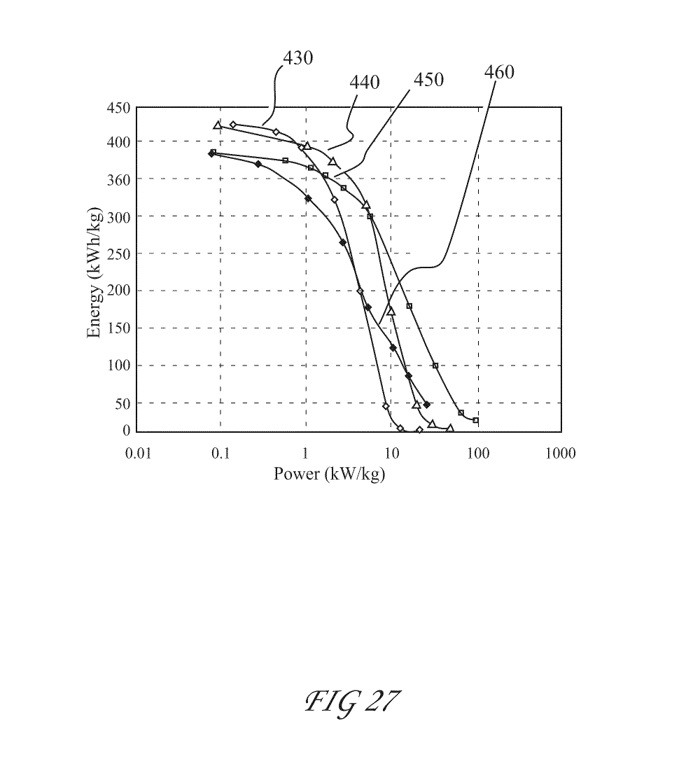

The electrodes made in Examples 2 and 3 where made into full-cells comprising silicon/CNT/binder anodes and lithium cobalt oxide/CNT/binder cathodes and the electrolyte/solvent combination of 1M LiPF6/ethylene carbonate(EC)/diethylene carbonate(DEC). The batteries were tested using a NEWARE™ Battery Testing System model V-BTS8-3, (BTS,) obtained from AA Portable Power Corp, Richmond, Calif. Charge/discharge cycles were performed and an example of a result is shown in FIG. 25 wherein the shape of the charge and discharge curves appears similar to those of cells made using traditional sheet type separators. Half-cycle capacity data is shown in FIG. 26 demonstrating little fade in capacity over nearly 80 cycles. FIG. 27 shows Power/Energy comparisons made with two cells made in accordance with Example 3, Particle Separator Cell Data 440 and 450, and two cells made with traditional sheet tri-layer separator material, Sheet Separator Cell Data 430 and 460. Impedance data was collected for three particle separator cells using separators made in accordance with Example 2, Particle Separator Cell Data 390, 400, and 410 with cells incorporating sheet separators, Sheet Separator Cell Data 420. The cells incorporating particle separators repeatedly demonstrated lower impedance than those made with sheet separators. Lower impedance is believed to indicate greater ion permeability through the cell's separator resulting in the ability to discharge energy at higher rates.

1. A battery electrode comprising:
a) an electrode having a surface, said electrode comprising:
i) a plurality of active material particles; and,
ii) a plurality of electrically conductive particles, wherein said active material particles are capable of reversibly storing ions;
a separator layer upon said electrode surface, said separator layer having top and bottom surfaces, said bottom surface facing said electrode surface, said separator layer comprising:
i) a plurality of organic polymer particles, each particle having a gross cross sectional dimension between 1 nm and 250 μm and comprising a plurality of organic polymer chains, wherein at least some of said organic polymer chains are covalently cross-linked to each other; and,
ii) a polymeric hinder, wherein said plurality of organic polymer particles are embedded in said polymeric binder.

2. The electrode of claim 1 further comprising a current collector in electrical communication with said electrode.

3. The electrode of claim 1 wherein said plurality of organic polymer particles are porous.

4. The electrode of claim 1 wherein said plurality of organic polymer particles are substantially non-porous.

5. The electrode of claim 1 wherein said separator layer comprises pores having a pore diameter and that are permeable to lithium ions, said separator being substantially not electrically conductive.

6. The electrode of claim 5 wherein said pores have a monomodal pore size distribution ranging from about 5 nm to 500 nm.

7-23. (canceled)

24. The electrode of claim 1 wherein said organic polymer chains comprise polymers selected from the from the group consisting of: acrylonitrile butadiene styrene (ABS); allylmethacrylate; polyacrylonitrile (PAN) or acrylic; polyamide; polyaramides; polybutadiene; polybutylene terephthalate) (PBT); polycarbonate; polychloroprene; poly(cis-1,4-isoprene); polyester; poly(ether sulfone) (PES, PES/PEES); poly(ether-ether ketone)s (PEEK, PES/PEEK); polyethylene (PE); poly(ethylene glycol) (PEG);
poly(ethylene terephthalate) (PET); polyethylene oxide (PEO); poly(2-hydroxymethylmethacrylate); polypropylene (PP); poly(trans-1,4-isoprene); poly (methyl acrylate); poly (methyl methacrylate); polytetrafluoroethylene (PTFE); poly(trimethylene terephthalate) (PTT); polyurethane (PU); polyvinyl butyral (PVB); polyvinylchloride (PVC); polyvinylidenedifluoride (PVDF); poly(vinyl pyrrolidone) (PVP); nylon; silicone rubbers; sodium polyacrylate; styrene-acrylonitrile resin (SAN); polymeric organosilicon; polydimethylsiloxane; and, ethylene glycol dimethacrylate.

25. The electrode of claim I wherein the polymer binder comprises a polymer selected from the group consisting of: acrylonitrile/butadiene rubber (NBR); agarose; alginate; butyl rubber; carboxymethylcellulose; casein; ethylene/prolylene/diene terpolymer (EPDM); gelatin; guar gum; hydroxymethylcellulose; hydroxyethylcellulose; hydroxyl ethyl methyl cellulose; hydroxypropylcellulose; isobutylene-maleic anyhydride copolymer; ethylene-maleic anyhydride copolymer; pectin; polyethylene glycol; polyacrylnitrile; polyacrylic acid; polyimide; polyurethane; polyvinyl alcohol; neoprene; polyiosobutylene (PIB); starch; styrene/acrylonitrile/styrene (SIS) block copolymers; styrene/butadiene rubber (SBR); styrene/butadiene/styrene (SBS) block copolymers; styrene-maleic anyhydride copolymer; and, xanthum gum.

26. The electrode of claim 1 wherein said separator layer further comprises a plurality of layers.

27-47. (canceled)

48. The electrode of claim 1 wherein the electrode forms part of a lithium ion battery cell having a cell chemistry, said polymer binder comprising polymers compatible with said lithium ion battery chemistry.

49-79. (canceled)

80. A method for making a separator comprising;
a) providing a first electrode having a surface, said electrode comprising:
i) active particles; and,
ii) conductive particles;
b) applying a coating to said surface of said electrode, said coating comprising:
i) a plurality of organic polymer particles, each particle having a gross cross sectional dimension between 0.1 μm and 250 μm and comprising a plurality of organic polymer chains,
wherein at least some of said organic polymer chains are covalently cross-linked to each other; and,
ii) a polymeric binder,
wherein said plurality of organic polymer particles are embedded in said polymeric binder,
wherein said coating, when formed, is substantially ion permeable and substantially electrically non-conductive.

81. The method of claim 80 wherein said applying step comprises spraying said coating onto said electrode surface.

82. The method of claim 81 wherein said spraying comprises electrospraying.

83. The method of claim 81 wherein said spraying comprises powder coat spraying.

84. The method of claim 81 wherein said spraying comprises dry spraying.

85. The method of claim 80 wherein said applying step comprises using a doctor blade applicator to apply said coating onto said electrode surface.

86. The method of claim 80 wherein said applying step using comprises a slot-die applicator to apply said coating onto said electrode surface.

87. The method of claim 80 wherein said applying step comprises using gravure to apply said coating onto said electrode surface.

88. The method of claim 80 wherein said applying step comprises using inkjet-style printing to apply said coating onto said electrode surface.

89-111. (canceled)

112. The method of claim 80 further comprising multiple applying steps to form a multilayered separator comprising a plurality of layers.

113-136. (canceled)
